(19) United States
(12) Patent Application Publication
(10) Pub. No.: US 2026/0199791 A1
(43) Pub. Date: Jul. 16, 2026

(54) ASSET ACCESS SYSTEM AND METHOD

(71) Applicant: Sony Interactive Entertainment Inc., Tokyo (JP)

(72) Inventors: Paul Terence Mulligan, London (GB); Radu-Andrei Nedelcu, London (GB)

(73) Assignee: Sony Interactive Entertainment Inc., Tokyo (JP)

(21) Appl. No.: 19/450,245

(22) Filed: Jan. 15, 2026

(30) Foreign Application Priority Data
Jan. 15, 2025 (GB) 2500521.6

(51) Int. Cl. A63F 13/77; A63F 13/35; A63F 13/52

(52) U.S. Cl. CPC A63F 13/77; A63F 13/35; A63F 13/52; A63F 2300/207; A63F 2300/5593

(57) ABSTRACT

A method of pre-accessing application assets comprises the steps of generating a current application state fingerprint comprising a plurality of values from predetermined memory locations used by the application, and comparing the current fingerprint to a plurality of fingerprints in a database; if the current fingerprint meets a matching criterion with a fingerprint in the database, then obtaining asset pre-access data associated with the fingerprint in the database, and scheduling pre-access of at least part of the asset or assets identified in the asset pre-access data prior to when they would next be accessed by normal operation of the application.

### CROSS-REFERENCE TO RELATED APPLICATIONS

This application claims the benefit of and priority to United Kingdom (GB) Application No. 2500521.6, filed Jan. 15, 2025, the entire disclosure of which is incorporated by reference herein in its entirety for all purposes.

### BACKGROUND OF THE INVENTION

The present invention relates to an asset access system and method.

In conventional videogames it is known to pre-load upcoming assets, such as character models and animations, environments, and video cut-scenes, before they are made available to the player, in order to provide a seamless experience without loading screens and the like during game play. This pre-loading may be in terms of loading from local storage into memory, and/or from a cloud based instance to a client. The difference in these two cases is typically one of available bandwidth and how far in advance one can reasonably predict the need for a respective asset.

The loading of such assets is often masked from the user by forcing the user to wait in an elevator, airlock, corridor or other small part of an environment that can be provided in common between two sets of assets; the user enters the region included within the old assets, and exits the region as included in the new assets.

However, for more modern games, and less linear games (e.g. so-called open-world games and procedurally generated games), such an approach is typically not available or is not as easy to implement because the users have much more choice as to where they go next.

However, the problem of pre-loading assets still remains.

The present invention seeks to address or mitigate this problem.

### BRIEF SUMMARY OF THE INVENTION

Various aspects and features of the present invention are defined in the appended claims and within the text of the accompanying description.

In a first aspect, a method is provided for generating a current application state fingerprint comprising a plurality of values from predetermined memory locations by an application; comparing the current application state fingerprint to a plurality of application state fingerprints in a database; determining the current application state fingerprint meets a matching criterion with an application state fingerprint in the database; obtaining asset pre-access data associated with the application state fingerprint in the database; and scheduling pre-access of at least one application asset identified in the asset pre-access data prior to when the at least one application asset would next be accessed by normal operation of the application.

In another aspect, a system is provided. The system comprising a processing system, a memory configured to store computer-executable instructions, and a processor configured to access the memory and execute the computer-executable instructions to at least: generate a current application state fingerprint comprising a plurality of values from predetermined memory locations used by the application; compare the current application state fingerprint to a plurality of application state fingerprints in a database; determine if the current application state fingerprint meets a matching criterion with an application state fingerprint in the database; obtain asset pre-access data associated with the application state fingerprint in the database; and schedule pre-access of a least one application asset identified in the asset pre-access data prior to when the at least one application asset would next be accessed by normal operation of the application.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is a schematic diagram of an entertainment device in accordance with embodiments of the description.

FIG. 2 is a flow diagram of a method of asset access in accordance with embodiments of the description.

### DETAILED DESCRIPTION OF THE INVENTION

An asset access system and method are disclosed. In the following description, a number of specific details are presented in order to provide a thorough understanding of the embodiments of the present invention. It will be apparent, however, to a person skilled in the art that these specific details need not be employed to practice the present invention. Conversely, specific details known to the person skilled in the art are omitted for the purposes of clarity where appropriate.

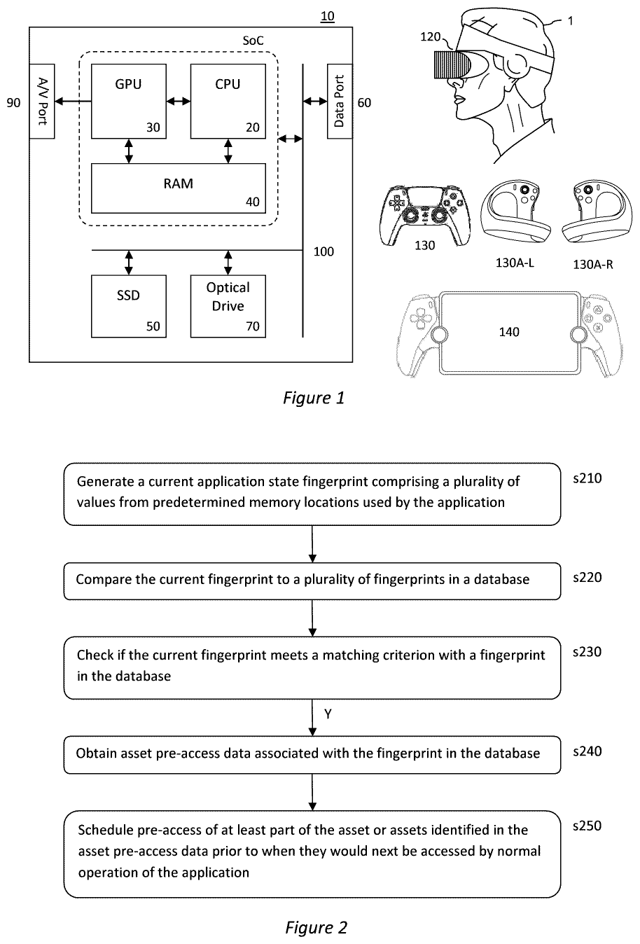

Referring now to the drawings, wherein like reference numerals designate identical or corresponding parts throughout the several views, FIG. 1 shows an example of an entertainment system 10 such as a computer or console.

The entertainment system 10 comprises a central processor or CPU 20. The entertainment system also comprises a graphical processing unit or GPU 30, and RAM 40. Two or more of the CPU, GPU, and RAM may be integrated as a system on a chip (SoC). Further storage may be provided by a disk 50, either as an external or internal hard drive, or as an external solid state drive, or an internal solid state drive.

The entertainment device may transmit or receive data via one or more data ports 60, such as a USB port, Ethernet® port, Wi-Fi® port, Bluetooth® port or similar, as appropriate. It may also optionally receive data via an optical drive 70. Audio/visual outputs from the entertainment device are typically provided through one or more A/V ports 90 or one or more of the data ports 60. Where components are not integrated, they may be connected as appropriate either by a dedicated data link or via a bus 100.

Examples of a device for displaying images output by the entertainment system include a head mounted display ‘HMD’ 120 worn by a user 1, a TV (not shown), and a portable screen 140.

Interaction with the system is typically provided using one or more handheld controllers 130, 140, and/or one or more VR controllers (130A-L,R) in the case of the HMD.

The use of a solid state drive can mitigate the previously mentioned problems by reducing the time taken to access assets from long term storage, but alone is typically not enough to fully mitigate the problem, and particularly when the entertainment system is working near to computational and/or memory capacity, or is working near memory or network transfer capacity, or also includes potentially longer lag times of a cloud streaming service.

### Fingerprints

Accordingly, in an embodiment of the present description, the entertainment system generates a game-state fingerprint for the currently played game, indicative of what is happening in the game (or at least relevant parts of it), in order to compare this with fingerprints of the game previously generated by the entertainment systems of other players. These recorded fingerprints are associated with information about what assets were used next during game play.

When a generated fingerprint sufficiently matches one on record, then identifiers for subsequently used assets of that matched instance can be provided as a prediction of what the entertainment system is likely to need next.

It then becomes possible to load the assets in advance, optionally when there are periods of available memory/network bandwidth, thereby reducing latency when the assets are needed, and better utilising the bandwidth available.

In embodiments of the present disclosure, a game state fingerprint comprises values from tracked points in the memory of the entertainment system.

The points in memory typically relate to changes in game state driven by the user or in response to the user, such as in-game location, avatar status (e.g. pose, class, abilities), non-player character statuses, virtual camera view point, global environmental variables such as lighting (e.g. day/night, sun/cloud), and recent or current player inputs.

These points may be provided by a developer to assist with the techniques herein, or may be evaluated empirically; in particular, these points in memory will be variables that, unlike game code, change with game play; as a result memory values at these points associated with the game process (rather than, but not necessarily, for example with graphical or audio assets) that change over time can be treated to a first approximation as the empirically determined fingerprint of the game state.

Such memory values can also be compared player to player across a corpus of players, and exclude those that do not differ between them from consideration as they do not provide a discriminatory function. Hence to a second approximation a fingerprint comprises memory values that change and differ within the evaluation corpus of play-throughs used to identify the fingerprints. The more play-throughs conducted, the better this estimate of the memory values that should contribute to the fingerprint will be.

Other strategies may be considered as well; for example when a save game is loaded, values found in the save game will appear within the game process memory. These are very likely to be relevant to defining the state of the game, since this is what the save game file does. Hence identifying these changed memory points can create a template footprint, or a starting set of candidate points in further compiling a footprint.

Notably, it is not necessary to know what these values actually represent in the game; they are merely patterns representative of changes within the game and hence indicative (preferably, but not necessarily, uniquely) of a state of the game In order to compare such finger prints between separate instances of a game, it can be necessary to normalise them; different instances of a game may occupy different areas of memory, for example depending on what other code is running in the background at the time. Hence values for notionally the same aspects of game state may be in different locations for different game instances.

However, it will be appreciated that those game instances themselves can keep track of such points in memory.

Accordingly, pointer chains may be used to identify points in memory and hence that their memory values represent specific attribute in gameplay, or at least consistent attributes. Hence in a game if there is a specific value such as the player's health level, it can be assigned in-memory to whichever block of memory is available. So for one player it might be in memory position 2006, and for another 8500. However, there will be a chain of pointers which can be followed through the memory assignments to find the original location of this value, which is always the same. Hence this enables the value at respective memory positions for two players to correspond to the same meaning, which may for example be health level (even if in practice it is not known by the system that is what it represents).

By identifying the original locations of each value, the fingerprint can be built independent of the actual instance-specific memory allocations of a current game.

This enables the comparison of fingerprint values a, b, c, etc. between players so that a is compared to a, b is compared to b, and so on. Even if these values are spread out across memory in different places in each game instance, the pointer chains can be followed to get the original assignment of each value so that like can be compared to like.

Hence more generally, memory values relating to game play that change during game play and can differ between different instances of game play can be identified, independent of a specific memory allocation, as part of a fingerprint that has a strong (and preferably unique) correspondence with the game state.

### Fingerprint Recording

Fingerprints can be taken periodically, but alternatively or in addition can be event triggered; e.g. when a threshold number of the memory points contributing to the fingerprint have changed value, and/or when one or more such memory values have changed by a threshold amount.

The threshold number of changing values may be one, i.e. creating a fingerprint every time any value changes, or may be a larger number (or percentage/proportion of numbers) depending on how many memory values contribute to the fingerprint.

The threshold amount may also be a de minimis value such a one, or may be a larger number (so if a memory value increments continuously e.g. because it represents a race time or race distance, it only triggers a fingerprint when the value reaches a significant round number, for example).

The threshold amount number may be different for different memory points, for example based on the range of values encountered over many finger prints—this will serve to fill-out the valid value ranges of the memory points and hence what counts as a significant value change; for some memory points, the value may be a flag and so a switch from 0 to 1 is significant; meanwhile for others the value may be between 0 and 65535, in which case a change of 1 is much less likely to be significant.

Hence by optionally using the above thresholds, the system can self-calibrate the number of fingerprints to take.

Alternatively or in addition, an outcome-based criterion can be used to trigger a fingerprint, viz., when a threshold number of assets have been loaded/streamed, or a threshold amount of asset data. This information could be associate either with the preceding fingerprint or the next (or both) and trigger the next fingerprint being taken-In this way fingerprints would only be taken when there is sufficient cumulative loading or streaming of assets (and hence a potential need to predict this).

In any case, the fingerprint may then be stored locally, or more typically uploaded to a central administrative server along with information about the game title and optionally any other useful information, such as a particular game level, open quest, or the like, If this is known (e.g. if the game has been developed to make use of the techniques herein) as this can make subsequent searches for matches more efficient, but is not necessary if not known.

### Database

In embodiments of the present description, a database of fingerprints and associated data is compiled.

This may be done for example during quality assessment of the game, or during early adopter play, or may start or continue after the game is released to the wider public.

As noted above, the memory points of the fingerprint may be identified/provided by the developer of game, or may be determined empirically based on comparisons of candidate memory points across numerous game play instances as described elsewhere herein.

Once a fingerprint is established, it can be recorded as a proxy for the state of the game during gameplay, at times as discussed elsewhere herein, in the database.

Notably, other data is also recorded in association with the fingerprint. In particular, identifiers of assets loaded into memory (or streamed to a client) by the game within a predetermined window of time relative to the moment represented by the fingerprint.

In one case, the window of time may immediately follow the moment represented by the fingerprint. In this case, the fingerprint is therefore associated with data indicating what assets were needed in the predetermined period after that game state.

In an alternative case, the window of time may immediately precede the moment represented by the fingerprint. In this case, the fingerprint is therefore associated with data indicating what assets were needed in the predetermined period leading up to that game state. This may be easier to record than waiting for assets to be needed after the fingerprint has been created. In this case, if fingerprints are linked or stored sequentially, then a match for a fingerprint can be used to access the indicated assets associated with the next fingerprint.

It will be appreciated that a fingerprint could be associated with both types of associated data, equivalent to the fingerprint being recorded in the middle of a predetermined window of time.

In any event, identification of a fingerprint in the database then allows for identification of what assets were needed subsequently for the game state corresponding to that fingerprint-either based on directly associated data, or on data associated with a subsequent fingerprint, as described above.

Optionally, one or more of the following may be recorded as part of the associated data:
i. The number of assets that were loaded or streamed;
ii. the order in which assets were loaded or streamed;
iii, the relative timing at which assets were loaded or streamed;
iv. the size of the asset(s) that were loaded or streamed;
v. the time taken for the asset to be loaded or streamed; and
vi. the level of memory or streaming bandwidth utilisation.

In this way, information about the potential order of priority of assets, and how much of and for how long they might occupy loading or streaming paths, may be made available to plan whether and how to load or stream the assets in advance of their use.

For example, knowing if there are a greater than average number of assets to load or stream (or any suitable threshold number) may be a trigger to implement mitigations such as pre-loading/streaming of assets. Similarly, if the assets to load or stream are particularly large (e.g. sum to more than a threshold amount) this may again be a trigger. The thresholds themselves may in turn depend on current bandwidth utilisation and/or predicted utilisation from the associated data.

Once triggered, information about the previous order or timing of assets can be used to provide a similar pattern of access now, or used to schedule completion of pre-loading/streaming in time for use.

### Matching and Prediction

In operation, fingerprints are generated from memory points as discussed elsewhere herein.

When a fingerprint is generated, it may then be matched to fingerprints in the database. This may be done by any suitable matching strategy.

In one example, an exact match may be required.

In another example the closest match may be identified, and optionally is only selected if the match is to within a predetermined tolerance. In this case, further optionally the tolerance may be on a per value basis since, as noted elsewhere herein, similar changes in absolute values can have different meanings and significance depending on the range of values that a memory point can adopt.

It will be appreciated that for a given game, the possible number of generated fingerprints may be very large. However, a goal of the fingerprint matching is to determine what assets will be needed, typically within the order of fractions of seconds to tens of seconds in the future. As a result the search needs to be quick. Consequently, further strategies may be used to make the search more efficient.

Hence in embodiments of the description, a subset of N memory points within a fingerprint may be searched for first; in other words, search for a truncated footprint to identify a plurality of matches that are then candidates for a further search for the remainder of the footprint.

The subset of memory points can be chosen based on an analysis of the footprint database. They may be the N most variable values, and so likely to result in the smallest number of matches to then search through further, but potentially at the risk of not finding an exact match and then potentially having to search in full. Alternatively they may be the N points that divide the largest subsets of footprints depending on values. Clearly a combination may be chosen.

Another approach is to look at the variability of the values within the database, and treat this as an order of significance. The fingerprints can then be sorted according to this order so that the fingerprint is akin to an address within the sorted list. The order of significance can be based on variability as noted above (e.g. least to most), or can be based on the average size of the group of fingerprints that exist after matching the first N points chosen, with smaller being better. Again in this case highly variable points may produce the smallest child groups but risk non-matches. Hence optionally another criterion is that for any point chosen for the first N, then for each value found in the database there must be or have been at least two instances. A fingerprint in the database can be associated with a match counter to keep track of how often it is being generated by client devices.

The above strategies assume there is little or no context for the fingerprint itself and so a full search of the database is required.

However, further contextual information may be available, that includes any information that relates to where in the game the player is—for example a level, quest, or location, if known, or more generally a current operation of the application. Fingerprints can then be organised according to such information, or associated with it, so that only a sub-set of fingerprints relating to the current context needs to be searched. The search can then optionally also utilise any of the search strategies mentioned above.

Even if such information is not available, there is typically one other important source of context available—the previous matching fingerprint(s) found during game play. Since the purpose of the fingerprints is to assist with predicting future play, there is typically a strong correlation between successive fingerprints—particularly if their creation is being triggered by threshold changes in values.

Hence whilst different players may make different choices and create branching patterns of fingerprints, these sequences and branches can be recorded as associative links between fingerprints, so that the fingerprint(s) that follow on from the last matching fingerprint can be tested first as potential matches for the currently generated finger print.

To enable quick location of the previous matching fingerprint(s), the database can return the ID of a matching fingerprint when also returning information about assets that could be pre-accessed. Consequently, the client device can include this ID together with the currently generated fingerprint, and the ID in effect can act as the address of the previous fingerprint, taking the search directly to its associative links for candidate matches to the current fingerprint.

As well as being quick within the search, it is beneficial to be low latency as well. Hence optionally rather than requesting a search from a central database, a block of the database can be requested for a local (e.g. in-memory) search. The block can comprise the database entries associated with the first N points chosen from the footprint (if low variability), and retained until one of those N points changes value. Alternatively or in addition the block can comprise the database entries with associative links branching out from the last match, for one or more future generations of links (e.g. up to a maximum size of data entries). This data can be obtained during periods predicted to have low loading/streaming bandwidth requirements by the system itself. The block may also relate to the current operation of the application, e.g. the current level, quest, and/or location in the game. Having the portion of the database most likely to contain a match be local to the system avoids any additional access latency, which increases the available time to manage asset transfer after the match has been found, and hence will generally improve the performance of the asset transfer management as it will have more scheduling time available before the assets are needed.

### Populating the Database

If a fingerprint is new, it can of course be added to the database together with any associated data (e.g. about subsequently loaded assets).

It can be expected that initially all fingerprints are new, but over time as the database is populated, new fingerprints will become increasingly rare. However, whenever a quality assurance tester, beta tester, or early adopter encounters a game state sufficiently new to trigger the creation of a fingerprint, that state will be added to the database-so for all but one first user, any given state will have predictive assistance available from the database.

As noted above, new fingerprints can be added to the database in relationship to other fingerprints based on N points selected from the fingerprint, and/or based on the previous fingerprint from the same source. The database itself can also be partitioned according to game context such as level, location, quest, and the like, or different respective databases can be created according to such game contexts.

### Populating a Second Database

It will be appreciated that when a new fingerprint is generated, the assets that are loaded/streamed afterwards are ‘raw’ in the sense that they are loaded without predictive help from the database, and the information about their loading/streaming is then included in the database to help future instances of the game to manage timely access to these assets.

However, this means that the existence of the database can change both the timing of asset access and also the occupancy of memory and bandwidth for loading/streaming.

Accordingly, optionally a second database may be generated that provides information about have the system behaves when it is using predicted asset access management. This data can provide information about how the assets are loaded/streamed one predictive information is available. In principle, this data could replace the data associated with a fingerprint once that fingerprint has been used by a client device in the original database, instead of generating a second database; the client device can report back on the modified behaviour. In either case, in this way a database can be bootstrapped to a situation in which it is predicting how to access assets when in a system with asset prediction.

### Associated Data Contention

It is possible that the same footprint may result in different assets (or different orders, timings, priorities) of assets being subsequently accessed. This may for example be because an accessibility setting means that only a greyscale asset is required instead of a colour one, and so different or less data is needed.

In this case, preferably the memory points contributing to the footprint are reassessed to determine if a further memory point can be identified that correlates with this difference in game state (e.g. a memory point associated with the accessibility setting).

However, it can be assumed that (unless a full list is provided by developers), an empirically estimated footprint will not be perfect at uniquely identifying all game states, and so for at least some footprints there will be a one: many relationship with the subsequent asset data to associate with them.

In this case, frequency counters and optionally order indices can be stored with the asset IDs. This can indicate that there are multiple options for this footprint, and either the client may choose to ignore or not access the asset IDs, or it can speculatively access the most frequently identified assets, optionally in the most frequent order. Optionally the system may be set up to the client device sometimes does not speculatively access identified assets in such cases, so that further ‘raw’ data can be generated to refine the frequency counters and optional order indices at the database to improve the odds of accessing the correct data.

Alternatively or in addition, where one fingerprint maps onto plural game states, then the system may look at one or more prior fingerprints from the client system to form an extended fingerprint, on the basis that different game states are likely to have different histories and these may have distinct fingerprints. The assets associated with the fingerprint at issue may then be associated with the or each prior fingerprint that is distinct, if one exists. In this way the path of fingerprints leading to the crossroads of the current fingerprint can help to disambiguate which subsequent assets are relevant.

### Fingerprint Simplification

Using several fingerprints as an extended fingerprint provides additional discriminatory ability due to the combinatorial effect of two separate game states. Consequently optionally the system may use a simpler fingerprint (e.g. fewer memory points) but two or more fingerprints in succession to characterise the current game state. This may simplify the fingerprint formulation process, and potentially also the database comparison by identifying a simpler current fingerprint first and then refining the match using the linked one or more preceding fingerprints.

### Extending Prediction

When fingerprints are stored in sequential/branching association, the probability of the next fingerprint based on the current fingerprint can be empirically determined based on how frequently different branches are visited; accordingly, the probability of the next game state can be estimated.

Moreover, based on the subsequent assets associated with the possibly next fingerprint, the probability of those subsequent assets being needed can also be estimated.

| Fingerprint | Probability | Associated subsequent assets | | | |
|---|---|---|---|---|---|
| Branch 1 | 0.5 | A | B | | |
| Branch 2 | 0.3 | | B | C | |
| Branch 3 | 0.2 | | B | C | D |
| Branch 4 | 0.1 | A | | | D |

The probability of needing the assets is then as follows: A−0.6, B=0.9, C=0.5, and D=0.3.

Therefore, after loading the assets predicted for the current fingerprint, then if not already loaded the apparent speculative order of loading future assets should be B, A, C, and D, subject to any limits on memory and bandwidth occupancy. In other words, these future assets could be considered an extension of the assets identified as subsequent to the current fingerprint, to smooth out asset access event further.

### Restricted Use

Optionally, the use of fingerprints to characterise the game state and predict asset loading/streaming requirements may be conditional on one or more criteria. These may include the memory occupancy of the system, where the prediction relates to loading assets from cold storage (e.g. HDD or SSD) into memory (general or graphic memory) or loading assets from general memory into graphics memory. In this case, if memory occupancy is high, optionally prediction is not performed as there may not be space to pre-load assets whilst current assets are in use. Alternatively, the occupancy may be used to select which asset to pre-load that would fit the available space, and pre-load as space becomes available.

The criteria may similarly include memory bandwidth occupancy-again preloading may be optionally be performed when occupancy is low (i.e. after or between other memory transfer activities). This limits any impact of the approach on other functions, but still helps for example if the overall bandwidth can cause delays when large amounts of asset data is needed by spreading it out. Alternatively if occupancy is high but this is due to activities unrelated to the application using the asserts, it may be advantageous to that pre-loading with the available bandwidth to avoid memory contention delays later on.

In short, any criterion that enables the pre-loading of assets preferably without affecting the normal use of other loaded assets or other memory transfers will be advantageous.

Corresponding criteria may be considered when streaming; in this case the transfer bandwidth will be streaming network bandwidth (e.g. data rates over the internet) to the client device, and the memory will be that of the client device, or a receiving buffer thereof.

Hence fingerprints may not be used as described herein either when existing transfer or memory occupancy levels militate against it, and/or conversely when they are so low as to suggest it is not needed. However, alternatively as noted above the finger prints can still be used, but the assets that are pre-loaded from the predicted assets are selected in response to memory occupancy and/or transfer conditions.

The criteria may also include changing fingerprint rate; for example the system may take fingerprints periodically whether using the system to pre-load assets or not. However, when a fingerprint is taken that does not have a suitable match in the database, then the system starts taking fingerprints at the normal rate and also uploading data about the related assets. In this way, the system can discover game states not yet covered by the database, and populate them.

The criteria may also include a remote control (e.g. from the developer or publisher), for example to use the fingerprinting and asset data to help populate the database, but once populated, turn off the supply of assert data by default. This enables the roll-out of a game, for example in early access, that builds the database, but then stops trying to contribute to it once the database is (or is largely) complete.

### Parallel Use in Cloud

When streaming to multiple users (potentially many thousands), there is the potential for peaks in streaming bandwidth to be very high, for example if all the players in a game area are shown a new enemy asset at the same time.

The predicted assets for pre-streaming for a plurality of clients can therefore be assessed together for their combined bandwidth, to pre-stream them in an order and/or at a timing calculated to help to even out the total bandwidth being streamed. Hence for example certain assets can be offset in time from a peak load time within the pre-streaming schedule. This can help to smooth out bandwidth peaks, at least at the head end (i.e. the network connection from the server that streams the combined data before it is routed to respective clients).

Turning now to FIG. 2, in a summary embodiment of the present description, a method of pre-accessing application assets (e.g. loading into memory, and/or streaming to a client), comprises the following steps.

In a first step s210, generating a current application state fingerprint comprising a plurality of values from predetermined memory locations used by the application (e.g. a game application), as described elsewhere herein.

In a second step s220, comparing the current fingerprint to a plurality of fingerprints in a database, as described elsewhere herein.

In a third step s230, checking if the current fingerprint meets a matching criterion with a fingerprint in the database, as described elsewhere herein;

And if so, in a fourth step s240, obtaining asset pre-access data associated with the fingerprint in the database, as described elsewhere herein.

And finally in a fifth step s250, scheduling pre-access of at least part of the asset or assets identified in the asset pre-access data prior to when they would next be accessed by normal operation of the application, as described elsewhere herein.

Once scheduled, the relevant system in a subsequent step can actually access the at least part of the asset or assets according to that schedule, so as to pre-access them.

It will be apparent to a person skilled in the art that variations in the above method corresponding to operation of the various embodiments of the apparatus as described and claimed herein are considered within the scope of the present invention, including but not limited to that:
the predetermined memory locations are identified empirically from comparing the memory of a plurality of application instances and selecting memory locations where one or more occur selected from the list consisting of: values differ, values change, and values are saved or loaded as part of an application state save or load process, to create a pattern of memory locations with values representative of changes within the application;
In this instance, optionally the memory locations are identified as equivalent between the plurality of application instances by using pointer chains to identify the common value source, as described elsewhere herein;
fingerprints are generated based on one or more selected from the list consisting of: a predetermined periodicity, when a threshold number of memory locations change value, when a memory location changes value by a threshold amount, when a threshold number of memory locations change value by a threshold amount, when a threshold number of memory locations change value by respective threshold amounts, and when a threshold amount or number of assets have been accessed, as described elsewhere herein;
entries in the database comprise application state fingerprints and identifiers of assets accessed within a predetermined window of time relative to the moment represented by the fingerprint, as described elsewhere herein;
In this instance, optionally the entries further comprise one or more selected from the list consisting of: the number of assets that were accessed, the order in which assets were accessed, the relative timing at which assets were accessed, the size of the asset(s) that were accessed, the time taken for the asset to be accessed, and the level of bandwidth utilisation during access, as described elsewhere herein;
in the method, the comparing step comprises the steps of comparing a truncated footprint comprising values from only a subset of predetermined memory locations within the fingerprint with values from corresponding predetermined memory locations of fingerprints in the database, and comparing values from further predetermined memory locations only if the truncated footprint meets a matching criterion with corresponding predetermined memory locations of a fingerprint in the database, as described elsewhere herein;
in the method, the comparing step comprises the steps of restricting the number of fingerprints in the database to search based on contextual data comprising one or more selected from the list consisting of: a current operation of the application, and a current level, quest, or location in a game application, as described elsewhere herein;
in the method, the comparing step comprises the step of restricting the number of fingerprints in the database to search based on contextual data comprising at least database identifier for the application state fingerprint generated prior to the current application state fingerprint, as described elsewhere herein;
the method comprises the step of obtaining a local copy of at least part of the database, responsive to one or more selected from the list consisting of: a current operation of the application, a current level, quest, or location in a game application, a matching fingerprint in the database, and a matching truncated fingerprint in the database, as described elsewhere herein;
the method comprises the step of, if the current fingerprint does not meet a matching criterion with a fingerprint in the database, adding the fingerprint to the database, and providing to the database identifiers of assets accessed within a predetermined window of time relative to the moment represented by the fingerprint, for association with the fingerprint in the database, as described elsewhere herein;
fingerprints in the database comprise associative links indicating sequential generation, and the relative frequency of respective associate links being followed, and the method comprises the steps of identifying possible future fingerprints based on the associated links, and their respective probabilities, identifying the assets for pre-accessing associated with each identified possible future fingerprint, calculating the cumulative likelihood of the identified assets being included in asset pre-access data with a future match, and additionally identifying for pre-access identified assets with a cumulative likelihood above a threshold value, as described elsewhere herein; and
a server provides assets to a plurality of clients, and the method comprises obtaining asset pre-access data for a plurality of the clients, and scheduling pre-access of at least part of the identified asset or assets for the respective clients according to a schedule that takes account of total network bandwidth at the server, as described elsewhere herein.

It will be appreciated that the above methods may be carried out on hardware suitably adapted as applicable by software instruction or by the inclusion or substitution of dedicated hardware.

Thus the required adaptation to existing parts of an equivalent device may be implemented in the form of a computer program product comprising processor implementable instructions stored on a non-transitory machine-readable medium such as a floppy disk, optical disk, hard disk, solid state disk, PROM, RAM, flash memory or any combination of these or other storage media, or realised in hardware as an ASIC (application specific integrated circuit) or an FPGA (field programmable gate array) or other configurable circuit suitable to use in adapting the conventional equivalent device. Separately, such a computer program may be transmitted via data signals on a network such as an Ethernet, a wireless network, the Internet, or any combination of these or other networks.

Accordingly, and referring again to FIG. 1, in a summary embodiment of the present description a system for pre-accessing application assets (e.g. loading into memory, and/or streaming to a client), comprises the following.

A fingerprint generation processor (e.g. CPU 20) configured (e.g. by suitable software instruction) to generate a current application state fingerprint comprising a plurality of values from predetermined memory locations used by the application, as described elsewhere herein;

A comparison processor (e.g. CPU 20) configured (e.g. by suitable software instruction) to compare the current fingerprint to a plurality of fingerprints in a database, as described elsewhere herein;

A matching processor (e.g. CPU 20) configured (e.g. by suitable software instruction) to determine if the current fingerprint meets a matching criterion with a fingerprint in the database, and if so to obtain asset pre-access data associated with the fingerprint in the database, as described elsewhere herein; and

An asset access processor (e.g. CPU 20) configured (e.g. by suitable software instruction) to schedule pre-access of at least part of the asset or assets identified in the asset pre-access data prior to when they would next be accessed by normal operation of the application.

The respective processors may all reside in a server (e.g. for memory management of the server, and/or scheduling streamed assets from the server, or may all reside in an entertainment device (e.g. for memory management of the device, and/or scheduling streamed assets from the server, in this case scheduling using advance requests); in this latter case the database may be wholly or partially stored locally to assist with comparison/match speeds. Alternatively, the data base may be stored at the server, in which case the fingerprint generation processor may be at the client device, the comparison and matching processors may be at the server, and the asset access processor may be at either the server or the client, depending on the source of the assets (server or entertainment device) and the nature of the access (into memory or from a network).

It will be appreciated that instances of this summary embodiment implementing the methods and techniques described herein (for example by use of suitable software instruction) are envisaged within the scope of the application.

The foregoing discussion discloses and describes merely exemplary embodiments of the present invention. As will be understood by those skilled in the art, the present invention may be embodied in other specific forms without departing from the spirit or essential characteristics thereof. Accordingly, the disclosure of the present invention is intended to be illustrative, but not limiting of the scope of the invention, as well as other claims. The disclosure, including any readily discernible variants of the teachings herein, defines, in part, the scope of the foregoing claim terminology such that no inventive subject matter is dedicated to the public.

1. A method comprising:
generating a current application state fingerprint comprising a plurality of values from predetermined memory locations used by an application;
comparing the current application state fingerprint to a plurality of application state fingerprints in a database;
determining that the current application state fingerprint meets a matching criterion with an application state fingerprint in the database;
obtaining asset pre-access data associated with the application state fingerprint in the database; and
scheduling pre-access of at least one application asset identified in the asset pre-access data prior to when the at least one application asset would next be accessed by normal operation of the application.

2. The method of claim 1, wherein the predetermined memory locations are identified from comparing a memory of a plurality of application instances and selecting memory locations where one or more occur selected from a list comprising:
i. values differ;
ii. values change; and
iii. values are saved or loaded as part of an application state save or load process, to create a pattern of memory locations with values representative of changes within the application.

3. The method of claim 2, in which the memory locations are identified as equivalent between the plurality of application instances by using pointer chains to identify a common value source.

4. The method of claim 1, wherein fingerprints are generated based on one or more selected from a list comprising:
i. a predetermined periodicity;
ii. when a threshold number of memory locations change value;
iii. when a memory location changes value by a threshold amount;
iv. when a threshold number of memory locations change value by a threshold amount;
v. when a threshold number of memory locations change value by respective threshold amounts; and
vi. when a threshold amount or number of assets have been accessed.

5. The method of claim 1, wherein entries in the database comprise application state fingerprints and identifiers of assets accessed within a predetermined window of time relative to a moment represented by the fingerprint.

6. The method of claim 5, wherein the entries further comprise one or more selected from a list comprising:
i. number of assets that were accessed;
ii. order in which assets were accessed;
iii. relative timing at which assets were accessed;
iv. size of the asset(s) that were accessed;
V. time taken for the asset to be accessed; and
vi. level of bandwidth utilization during access.

7. The method of claim 1, wherein comparing the current application state fingerprint to a plurality of application state fingerprints in a database comprises:
comparing a truncated footprint comprising values from only a subset of predetermined memory locations within the current application state fingerprint with values from corresponding predetermined memory locations of application state fingerprints in the database;
and comparing values from further predetermined memory locations only if the truncated footprint meets a matching criterion with corresponding predetermined memory locations of an application state fingerprint in the database.

8. The method of claim 1, wherein comparing the current application state fingerprint to a plurality of application state fingerprints in a database comprises:
restricting a number of application state fingerprints in the database to search based on contextual data comprising one or more selected from a list consisting of:
i. a current operation of the application; and
ii. a current level, quest, or location in a game application.

9. The method of claim 1, wherein comparing the current application state fingerprint to a plurality of application state fingerprints in a database comprises:
restricting a number of application state fingerprints in the database to search based on contextual data comprising at least database identifier for the application state fingerprint generated prior to the current application state fingerprint.

10. The method of claim 1, further comprising:
obtaining a local copy of at least part of the database, responsive to one or more selected from a list consisting of:
i. a current operation of the application;
ii. a current level, quest, or location in a game application;
iii. a matching fingerprint in the database; and
iv. a matching truncated fingerprint in the database.

11. The method of claim 1, further comprising:
adding the fingerprint to the database based on determining the current application state fingerprint does not meet a matching criterion with an application state fingerprint in the database; and
providing identifiers of assets accessed within a predetermined window of time relative to a moment represented by the current application state fingerprint to the database, for association with the current application state fingerprint in the database.

12. The method of claim 1, wherein the application state fingerprints in the database comprise associative links indicating sequential generation, and a relative frequency of respective associate links being followed, the method further comprising:
identifying possible future application state fingerprints based on the associated links, and their respective probabilities;
identifying the assets for pre-accessing associated with each identified possible future application state fingerprint
calculating a likelihood of the identified assets being included in asset pre-access data with a future match; and
additionally identifying for pre-access identified assets with a cumulative likelihood above a threshold value.

13. The method of claim 1, wherein a server provides assets to a plurality of clients, the method further comprising:
obtaining asset pre-access data for a plurality of the clients; and
scheduling pre-access of at least part of the identified asset for the respective clients according to a schedule that takes account of total network bandwidth at the server.

14. One or more non-transitory computer-readable storage media storing instructions that, upon execution by one or more processors of a system, cause the system to perform operations comprising:
generating a current application state fingerprint comprising a plurality of values from predetermined memory locations used by an application;
comparing the current application state fingerprint to a plurality of application state fingerprints in a database;
determining the current application state fingerprint meets a matching criterion with an application state fingerprint in the database;
obtaining asset pre-access data associated with the application state fingerprint in the database; and
scheduling pre-access of at least one application asset identified in the asset pre-access data prior to when the at least one application asset would next be accessed by normal operation of the application.

15. A system comprising:
a processing system; and
a memory configured to store computer-executable instructions; and
a processor configured to access the memory and execute the computer-executable instructions to at least:
generate a current application state fingerprint comprising a plurality of values from predetermined memory locations used by the application;
compare the current application state fingerprint to a plurality of application state fingerprints in a database;
determine if the current application state fingerprint meets a matching criterion with an application state fingerprint in the database;
obtain asset pre-access data associated with the application state fingerprint in the database; and
schedule pre-access of at least one application asset identified in the asset pre-access data prior to when the at least one application asset would next be accessed by normal operation of the application.
